(19) United States
(12) Patent Application Publication
(10) Pub. No.: US 2006/0010213 A1
(43) Pub. Date: Jan. 12, 2006

(54) Method for personal email archiving and organization for electronic data, including email, which can be utilized by both the user and the provider in a variety of ways

(76) Inventor: Jignesh Mehta, San Diego, CA (US)

Correspondence Address: ERIC HANSCOM, 7395 PORTAGE WAY, CARLSBAD, CA, 92011, US

(21) Appl. No.: 11/037,788

(22) Filed: Jan. 19, 2005

Related U.S. Application Data
(60) Provisional application No. 60/572,074, filed on May 19, 2004.

(51) Int. Cl. G06F 15/16

(52) U.S. Cl. 709/206

(57) ABSTRACT

This invention is directed to a method for electronic data exchange, including Email, which involves archiving and organizing a personal email management system used in electronic data communication and exchange system. The invention adds utility to existing internet-based email systems for enhancing user satisfaction by providing easy manageability of personal emails. The invention can also include a client system that allows users to archive and organize emails, and also to download important emails from their internet-based email system and help manage them through either email provider or by a client program residing on the user's system. Extending client program for email management would help user archive, download, upload and manage/organize emails from different email providing system. The invention also allows a user to interface email management from one or more computers, with one or more internet providers, and one or more software programs, such as virus scanning software, which can be located either on user's computer(s) or the email service provider. Furthermore, the methods taught by this invention can be available from any email service provider or third party via either internet-based systems, which may include the email system itself or other systems, or via client programs residing on the user's system.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF THE INVENTION

It appears that email will be to the 21^{st} century what the telephone was to the 20^{th} century: a radical improvement over the previous methods of communication. Email has greatly enhanced the ability to communicate internationally, as it is, relative to the telephone or facsimile machine, inexpensive and fast. Email also has the advantage of being easily forwarded to other interested parties. Email systems have become the major means of communication throughout industries and for personal use. There are a number of email service providers like Hotmail from Microsoft, Yahoo, and AOL—America Online, etc, offering internet based email services for personal use and for industries.

Email is made available to the majority of users through Internet Service Providers, or email service providers, which, for a fee, allow a customer email capabilities measured mainly with respect to the speed of communication and the amount of use. There are two components to the amount of use a customers gets for certain price: the amount of time he/she can access the internet, both for internet surfing and retrieving/writing emails, and the size of his/her email box, or the amount of space the email service provider allocates to the customer to store his/her emails on the email service provider's computer banks.

Many email service providers are offering customers a different size of memory space in which they can store the emails. This service helps user keep important emails in their email system for long time. Also, as use of internet emailing is continuously increasing, email service providers are offering more and more space, with additional charges, for users who regularly exceed their allotted mailbox size.

With increasing use of internet based email systems, it is desirable for service providers to offer customers with a variety of options for email management and security of their emails. There are some client tools available, like Outlook from Microsoft, Eudora, etc., which allow the user to view emails offline once downloaded. These client tools are synchronized with email server emails once connected to email server, but they are usually very expensive and remain proprietary to use with email service provider.

Along with its benefits, the enormous reliance upon email as a method of communication has produced a number of extremely serious problems. From time to time, an email service provider cease functioning, thereby depriving a user of access to online emails. A user's personal computer hard drive can also fail, losing some or all of the data on it. Email service providers usually sell their internet services to users in a method whereby a user pays a certain amount of money for a certain amount of space. When that space is full, the email service provider can refuse to accept further email for the user, which can be particularly devastating when a user cannot access his/her email for extended periods of time, such as when on a trip. Thus, there has existed a long-felt need for a well-organized method of allowing a customer greater flexibility in managing his/her email account.

There have been a number of attempts at improving email capabilities. For example, U.S. Pat. Nos. 6,438,594 and 6,434,568 to Bowman-Amuah teach interface methods by which a number of globally accessible interfaces can be accessed. These inventions, however, does not detail the complex email condensing and viewing capabilities of the current invention. U.S. Pat. No. 6,779,003 to Midgley, et. al., described a system and method for continuous backup of data stored on a computer network, but does not address the other aspects of the current invention. A patent representative of the virus-checking industry is found in U.S. Pat. No. 6,721,721 to Bates, et. al., which teaches a method and apparatus for protecting a computer from viruses during computer searches. Again, while this patent does provide a solution to part of the aforementioned problem, it does not address all the concerns which have been dealt with by the current invention.

The current invention meets these long-felt needs by providing a comprehensive method by which a user can more effectively manage email, and an email service provider can effectively sell email services to existing and potential customers.

### SUMMARY OF THE INVENTION

It is a principal object of the invention to provide a method by which email service providers can offer to an existing or potential customer an improved method of email management.

It is another object of the invention that an email service provider can sell email storage space to a customer based upon a variety of fee-based programs which offer the customer an attractive range of methods of upgrading his/her email retrieval and storage capability.

It is an additional object of the invention that the email service provider be able to perform various operations on the user's computer to enhance the ability of the user to retrieve, view, and store emails.

It is also an object of this invention that a user be able to use an internet service provider as a “backup” for emails contained on the user's computer, such that if the user's computer crashes and loses all email stored on it, the user can retrieve the backed up emails from the email service provider's computers.

It is a further object of the invention that the email service provider be able to offer virus scanning and password protection to the user at all levels of this invention.

It is also an object of this invention that the invention be functional when the email service provider is dealing with anything from a single computer to a network of computers.

It is another object of the invention that the user be able to view, retrieve, and store emails without having to download them from the email service provider.

It is also an object of the invention that a user of the invention be able to sort and store the emails by a wide variety of characteristics.

It is a final object of the invention that the emails a user stores can be transferred to a wide variety of hardware, including USB devices, flash memory cards, etc.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims 1 regard as my invention.

### DETAILED DESCRIPTION OF INVENTION

The invention is directed toward a method of enhancing the archiving, storage and retrieval of any form of electronic media. Email is the best mode of this invention and will be used to illustrate it, but it should be understood that this invention is also equally applicable to any form of electronic data storage, including but not limited to electronic data exchange on desktop computers, PDA's, cell phones, calculator watches, personal address books, and other devices.

The invention, using email as the example, comprises software which allows a user with one or more computers to interface with one or more ISPs or other email providing services, companies, and operations, each of which may have one or computer locations in which emails can be stored. (Please note: the term email service provider will be used for the duration of this provisional patent application and shall be meant to include all of the above methods by which a user of this invention can get email). The invention allows an email service provider to sell to a user a number of options for storing, archiving, and retrieving his/her email, including a variety of plans under which a user will not “fill up” his/her mailbox, such that email is no longer accepted by the email service provider. The email service provider can sell this service both to existing customers and to new customers, with the suggestion that offering an introductory low price, or even free service, to entice customers or potential customers to try the invention as offered by the email service provider will be a successful way to lure more customers into subscribing to the email service provider's services.

The invention also allows a user to select the preferences under which his/her email is archived and retrieved, including size, date, name and other common characteristics. The user can download and upload email, either compressed or uncompressed, under a variety of different systems, and, according to the package purchased from the email service provider, have access to this email under a variety of different plans. The larger size of the email service provider R storage bank will allow a user to not only store more emails in his/her account than would be possible on a smaller partition within his/her own computer, but also to facilitate the sending of larger files, including compressed or zip files. The download of email can be automated through set up or manual request, these functions to be set by the customer. This request can create automated email from the email service provider such that the email service provider sends email to customer via attachments that are the email(s) that customer selected for download. This function can be defaulted for each email or by preference like sender, company, date etc.

The invention also allows a user to view email on the email service provider and determine whether to retrieve that particular email to his/her personal computer, or store it on the email service provider. The user would also have the option to delegate some emails to “read only” or “view only” status, on either his/her personal computer or the email service provider, and by designating whether the emails are stored as compressed or uncompressed, determine how much space each email takes up. By allowing a user to instantly locate and find a “.zip” file for sending via email without having to first create one, the user will save time and avoid having to take a chance on losing data should he/she make an error creating the zip file.

The invention also provides a mechanism by which a user can choose the level at which he/she stores an email. Level options include browser, manager, system folder, small personal email manager, email archival database, and any generic software or tool that can manage or store and manage email and other information.

It is another purpose of the invention to allow a user to give one or more email service provider's access to his/her computer for the purpose of partitioning a section of the hard drive to accept email, either by user preference, automatically from the email service provider, or in a combination of these two methods. For example, a user could order the email service provider to allow for user-selection of email except during periods when the user is on vacation, during which the user could order the email service provider to deposit email directly into a set directory or partition on the user's hard drive. The user could even grant to the email service provider the right to expand the size of the partition or the open up additional storage files on the user's computer if the size of his/her email receipts determined that such action was necessary. The characteristic, along with others in the invention could be password protected at either or both the user end and/or the email service provider end, and there could also be a password arranged between the email service provider and the user so that access to the user's data on the email service provider would be regulated by the password.

It is an additional purpose of the invention to allow a user to interface the email uploading, downloading, and archival systems of this invention with software and devices made by other companies. Such external software could include operating system software, such as Windows, or goal-specific software, such as Norton Anti-Virus, a filter, or an internet browser. By allowing the user to use his/her own personal software, the user can utilize virus-scanning, address storage, and other important functions of a standard personal computer to enhance his/her use of the invention. The invention can also interface with devices such as PDA's, cells phones, USB flash memory and digital camera flash memory, such that information from the user's email systems, both on his/her personal computer and on the email service provider (s) can be stored on the devices, and information stored on the devices can be uploaded to the personal computer and/or email service provider (s).

The invention also allows an email service provider to charge fees based on numerous bases, including a fee/download or upload, a fee for a certain bulk number of downloads, and time span related fee, such as a monthly or yearly fee, which could cover a limited or unlimited number of downloads/uploads. email service provider fees could also relate to the compression characteristics of each download or upload.

1. A method by which an email service provider, including but not limited to an ISP or Internet Service Provider can sell email storage space to a customer, consisting of:
one or more existing account(s) on the email service provider with an existing customer of the email service provider, whereby the account has a size limit restricting the amount of emails the account will store,
software which will allow a customer to store more emails than his/her the account will store under the size limit,
the ability of the email service provider to allocate more space on the email service provider's computer bank to the customer in one or more locations on the email service provider, thereby allowing the customer to store additional emails above and beyond the size limit of his/her account,
software used by the email service provider which can download the additional emails and store them in the additional storage space,
the ability of the email service provider to download the additional emails from the customer's In-Box as provided by the email service provider, and,
the ability of the email service provider to provide password protection and virus scanning capabilities to the email downloading capabilities it provides to the customer.

2. The method of claim 1, where the email service provider's software allows it to download emails stored on one or more of the customer's personal computers to the additional storage space on the email service provider, including downloading of emails from a network of computers owned or operated by the customer, such that the customer can “backup” his/her email on the email service provider's computers.

3. The method of claim 1, where the email service provider's software allows it to compress the customer's emails, thereby taking up less space and perform a virus scan on the customer's emails as they are being stored on the additional space.

4. The method of claim 1, where the email service provider's software allows the customer to view his/her emails on the email service provider without the email service provider having to download the customer's emails to his/her computer.

5. The method of claim 1, where: the email service provider's software can organize the additional emails being stored on the additional space by some logical criteria, such as date, size, type of attachment, or sender.

6. The method of claim 1, where: the email service provider can charge the customer additional fees for the customer's additional use of the email service provider's storage capacity, including an additional flat fee per additional the email the customer wishes to charge on the computer bank of the email service provider, an additional flat fee per additional unit of storage space the customer wishes to add to his/her account, and an additional retainer fee, per unit time as decided by the email service provider, the retainer fee allowing the customer to reserve a certain amount of additional space and to pay the email service provider when he/she begins to use the additional space.

7. The method of claim 1, where: the email service provider's software allows the customer to interface his/her email capabilities, including downloading, uploading and archival systems, to interface with external software made by other companies, including external software that operates system software, goal-specific software such as anti-virus software, filters, and internet browsers.

8. The method of claim 1, where: the email service provider's software allows the customer to interface his/her email capabilities, including downloading, uploading and archival systems, to interface with hardware made by other companies, including cell phones, PDA's, USB stick memory, and digital camera flash memory.

9. The method of claim 1, where: the email service provider's software also allows the customer to perform uploading and downloading operations such that he/she can retrieve selected emails from the additional space on the email service provider and download emails from his/her computer to the email service provider, and where the email service provider's software allows the customer to control access to his/her personal computer(s) through password protection, and where the email service provider's software allows the customer to download and upload emails from more than one of customer's computers, including at least one of the following:
A. where: the email service provider's software allows the customer to perform virus scanning capabilities using the email service provider's software as the customer uploads and downloads email from the email service provider's additional storage space,
B. where: the email service provider's software is open-ended such that it allows the customer to perform virus scanning capabilities using the customer's own virus scanning software,
C. where the email service provider's software allows the customer to selectively compress and decompress email messages that he/she uploads from and downloads to the email service provider.
D. where: the email service provider's software allows the customer to organize his/her emails on the email service provider's additional space according to his/her own choice,
E. where: the email service provider's software allows the customer to view his/her emails on the email service provider without the email service provider having to download the customer's emails to his/her computer, where, where: the email service provider's software will also allow the customer to delegate the emails as “read only” or “view only” on both the email service provider's computer(s) and his/her own personal computer(s), thereby allowing the emails to be stored as compressed or uncompressed, thereby affecting the amount of space each email takes up and where the email service provider's software allows the customer to locate and send emails via “zip” files.

10. The method of claim 9, where: the email service provider's software allows the customer to select the level at which he/she stores the email, such levels including browser, manager, system folder, small personal email manager, email archival database, and any generic software or tool that can manage or store and manage email and other information, and where the email service provider can charge the customer an additional flat fee per additional email the customer wishes to upload and download on the computer bank of the email service provider, and where the email service provider will charge the customer an additional flat fee per additional number of uploads and downloads the customer wishes to add to his/her account, and where the email service provider can charge the customer a set fee per unit time, for example, per month, and during that time period the customer can perform unlimited uploads and downloads of his/her emails stored on the email service provider's additional storage, and where the email service provider can charge the customer an additional retainer fee, per unit time as decided by the email service provider, the retainer fee allowing the customer to reserve a certain number of uploads and downloads, and to pay the email service provider when he/she begins to perform the uploads and downloads.

11. The method of claim 9, where: the email service provider's software allows the customer to track the source of emails uploaded to the email service provider's additional space from more than one of customer's computers, thereby allowing customer to download that same email back down to the source computer.

12. The method of claim 9, where: the email service provider's software allows the customer to track the source of emails uploaded to the email service provider's additional space from a network of computers, some of which may be owned and operated by users other than customer, thereby allowing customer to download that same email back down to the source computer.

13. The method of claim 9, where: the email service provider's software allows the customer to allow access to his/her computer to one or more email service provider's for the purpose of storing, archiving or downloading email.

14. A method by which an email service provider can organize email storage for a customer, comprising:
an existing account on the email service provider with an existing customer of the email service provider, whereby the account has a size limit restricting the amount of emails the account will store,
software provided by email service provider by which the customer to store more emails than his/her the account will store under the size limit,
the ability of the email service provider to allocate space on the customer's computer, thereby allowing the customer to store additional emails above and beyond the size limit of his/her account on the customer's computer,
software used by the email service provider which can download the additional emails and store them on the customer's computer, and
the ability of the email service provider to download the additional emails from the customer's In-Box as provided by the email service provider onto the customer's computer.

15. The method of claim 14, where the email service provider's software allows it to perform one or more of the following functions:
A. download emails stored on the customer's email service provider account to the storage space on the customer's computer,
B. download emails from more than one email account used by the customer back down to that customer's computer,
C. upload emails from a network of computers owned by customer and download the emails back to the individual computers contained within the network,
D. compress the customer's emails before downloading the emails to the customer's computer, thereby taking up less space on the customer's computer,
E. perform a virus scan on the customer's emails as they are being uploaded from the customer's email box and downloaded onto the customer's computer,
F. perform virus scanning capabilities using the customer's own virus scanning software as emails are being downloaded onto the customer's computer,
G. the customer to view his/her emails on the email service provider without the email service provider having to download the customer's emails to his/her computer,
H. organize the additional emails being stored on the customer's computer by some logical criteria, such as date, size, type of attachment, or sender,
I. the customer to control access to his/her personal computer(s) and his/her email account(s) at the email service provider (s) through password protection,
J. charge the customer an additional flat fee per additional email the customer wishes to have the email service provider store back on his/her computer,
K. charge the customer an additional flat fee per additional email the customer wishes to have the email service provider store back on his/her computer,
L. charge the customer an additional flat fee per additional volume of email, measured in megabytes, that the customer directs the email service provider to store back on his/her computer,
M. charge the customer an additional retainer fee, per unit time as decided by the email service provider, the retainer fee allowing the customer to reserve a certain number of emails to be stored on his/her computer, and to begin paying the email service provider when he/she directs the email service provider to download one or more emails onto his/her personal computer,

16. The method of claim 14, where: the email service provider's software and an agreement with the customer allows the email service provider to partition the customer's hard drive, thereby allowing a set volume of the customer's hard drive to be reserved for emails download by the email service provider to the customer's computer, allow the customer to allow access to his/her computer to one or more email service provider's for the purpose of partitioning the hard drive on the customer's personal computer(s) for the purpose of storing email, allow the customer to perform uploading and downloading operations such that he/she can retrieve selected emails from his/her computer and upload emails from his/her computer to the email service provider, and allows the customer to perform virus scanning capabilities using the email service provider's software as the customer uploads and downloads email from the customer's computer.

17. The method of claim 16, where: the email service provider's software allows the customer to selectively compress and decompress email messages that he/she uploads from and downloads to his/her computer, with the customer having the ability to store the email messages on both the email service provider's computer(s) and the customer's own computer(s), organize his/her emails on his/her computer according to his/her own choice with respect to common functions such as size, date, and name, to view his/her emails on the email service provider without the email service provider having to download the customer's emails to his/her computer, and control access to his/her personal computer(s) and email accounts with the email service provider through password protection.

18. The method of claim 16, where: the customer can set the download of email to be automated through set up or manual request, whereby the customer can create automated email form the email service provider that send email to the customer with an attachment that is email which the customer can then download, and perform at least one of the following functions:
A. where the download of email function can be defaulted for each email or by preference such as sender, company, date, size, etc.,
B. the email service provider will charge the customer an additional flat fee per additional email the customer wishes to upload and download on his/her personal computer and the email service provider,
C. the email service provider can charge the customer an additional flat fee per additional number of uploads and downloads the customer wishes to add to his/her account,
D. the email service provider can charge the customer a set fee per unit time, for example, per month, and during that time period the customer can perform unlimited uploads and downloads of his/her emails stored on the email service provider's additional storage,
E. the email service provider can charge the customer an additional retainer fee, per unit time as decided by the email service provider, the retainer fee allowing the customer to reserve a certain number of uploads and downloads, and to pay the email service provider when he/she begins to perform the uploads and downloads,
F. the email service provider's software allows the customer to download and upload emails from more than one of customer's computers to the email service provider, and then download them back to the customer's computer of customer's choice,
G. the email service provider's software allows the customer to track the source of emails downloaded from the email service provider to his/her personal computer from more than one of customer's computers, thereby allowing customer to download that same email back down to the source computer, and
H. the email service provider's software allows the customer to track the source of emails downloaded to customer's personal computer from a network of computers, some of which may be owned and operated by users other than customer, thereby allowing customer to download that same email back down to the source computer.

19. A method of enticing potential customers to sign up with an email service provider by which the email service provider advertises the enhanced abilities, including a number of options for storing, archiving, and retrieving his/her email, including a variety of plans under which the customer can do so, via this invention, of the email service provider to assist a potential customer to manage his/her emails, through subscription to that particular email service provider, in situations where both a customer does not have any email accounts with any email service provider, and those in which a customer has one or more email accounts with another email service provider.
